(19) United States
(12) Patent Application Publication
(10) Pub. No.: US 2004/0177031 A1
(43) Pub. Date: Sep. 9, 2004

(54) Systems and methods for processing defaulted loans

(76) Inventors: Alex Z. Shapiro, Natick, MA (US); Michele Ann Holmes, Plymouth, MA (US); Robert G. Goldberg, Somerville, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/781,614

(22) Filed: Feb. 17, 2004

Related U.S. Application Data
(60) Provisional application No. 60/447,491, filed on Feb. 14, 2003.

(51) Int. Cl. G06F 17/60

(52) U.S. Cl. 705/38

(57) ABSTRACT

Systems and methods for processing defaulted loans are described. In some embodiments, the systems and methods process a defaulted loan by associating the defaulted loan with a loan state, identifying a loan event that relates the loan state to another loan state, and, based on detecting the identified loan event, performing a loan task associated with the identified loan event.

### REFERENCE TO RELATED APPLICATION

This application claims priority to U.S. Patent Application Serial No. 60/447,491, filed on Feb. 14, 2003, currently pending, the contents of which application are expressly incorporated by reference herein in their entirety.

### BACKGROUND

A loan is a type of interaction between a lender and a borrower. In a loan, the lender can lend the borrower a sum of money, and the borrower can agree to repay the sum of money to the lender under specified conditions. A student loan is a loan in which a lender lends a student a sum of money to attend a school.

A loan can also include an interaction with a guarantor. A guarantor is a third party who guarantees the obligation of the borrower to the lender. A student loan can include a guarantor who guarantees payment of the student's obligation to the school.

A loan enters default when the borrower fails to repay the loan to the lender under the specified conditions. On default of the borrower, the guarantor repays the loan to the lender. The guarantor assumes the position of the lender and seeks payment from the borrower.

Guarantors of defaulted student loans tend to face at least two challenges to efficient loan processing. First, data for processing the defaulted loans tends to be provided by different sources. These sources can include a federal treasury that intercepts a federal tax refund, a state treasury that intercepts a state tax refund, an employer who garnishes wages, and a court that issues a civil judgment. Second, legal regulations can specify procedures for defaulted student loan processing. For example, federal regulations can specify due diligence procedures for payment allocation, payment collection, and payment reporting.

A variety of schemes are currently available for processing defaulted loans. Many of these schemes do not permit efficient aggregation of information from payment sources and efficient loan processing according to legal regulations, thereby inhibiting their utility.

### SUMMARY

Systems and methods for processing defaulted loans are described.

In embodiments, methods for processing a defaulted loan include providing a group of loan states, loan events that relate the loan states, and loan tasks that are associated with the loan events. The methods further include associating the defaulted loan with a loan state, identifying a loan event that relates the loan state to another loan state and, based on detecting the identified loan event, performing the loan task associated with the identified loan event.

At least some of the loan states, the loan events, and the loan tasks are at least partially based on at least one governmental regulation. The governmental regulation includes one or more federal governmental regulations and/or one or more state governmental regulations.

The methods associate the defaulted loan with a loan state based on one or more characteristics of the defaulted loan. The one or more characteristics include a legal status, a length of a default period, a monetary balance, and a characteristic of a borrower.

The loan tasks include one or more of applying a payment to the defaulted loan, determining whether a borrower is eligible for a payment program of a payment source, generating a communication to a borrower, generating a communication to a non-borrower, and requesting a payment for the defaulted loan from a payment source.

In embodiments, the methods further include updating the loan state and iteratively return to identifying a loan event that relates the loan state to another loan state.

In embodiments, the identified loan event includes a synchronous loan event that relates the loan state to a chronologically next loan state. In some of such embodiments, the methods process a defaulted loan in part by converting the identified synchronous loan event to a loan event time and generating a first queue entry in a first queue for the identified synchronous loan event. The first queue entry includes data representing the loan event time and at least one of the defaulted loan, the loan state, the identified synchronous loan event, and the loan task associated with the identified synchronous loan event. The methods further process the defaulted loan in part by detecting a first queue time for the first queue that is not less than the loan event time. Based on detecting such a first queue time, the methods update the first queue to remove the first queue entry and generate a second queue entry in a second queue. The second queue entry includes data representing at least one of the defaulted loan, the loan state, the identified synchronous loan event, and the loan task associated with the identified synchronous loan event. The methods further process the defaulted loan in part by performing the loan task and updating the second queue to remove the second queue entry.

In embodiments, the identified loan event is asynchronous. In some of such embodiments, the methods detect the identified asynchronous loan event by receiving from a payment source at least one of payment data and processing data related to the defaulted loan. The payment source includes one or more of an administrative wage garnishment program, a borrower, a federal treasury offset program, a loan consolidation program, a loan rehabilitation program, a loan repurchase program, and a state treasury offset program. The processing data includes data related to an eligibility of a borrower for a payment program of the payment source. In some of such embodiments, the methods further process the defaulted loan in part by generating a second queue entry in a second queue, performing the loan task, and updating the second queue to remove the second queue entry. In embodiments, the identified loan event relates the loan state to a loan state in a different of group of loan states. The different groups of loan states are associated with different aspects of processing a defaulted loan relate to due diligence data collection and reporting and payment collection and reporting.

Systems for processing defaulted loans are also described. In embodiments, the systems include a group of loan states, loan events, and loan tasks and a digital data processing device that is in communication with the group of loan states and configured to execute features of the previously described methods.

Processor-readable mediums including instructions for processing defaulted loans are also described. The processor-readable mediums include instructions to cause a processor to execute features of the previously described methods.

These and other features of the disclosed systems and methods can be more fully understood by referring to the following detailed description and accompanying drawings.

### BRIEF DESCRIPTION OF THE DRAWINGS

FIG. 1 schematically illustrates an exemplary system for computing cash flows;

FIG. 2A shows an embodiment of a generic group of loan states for processing a defaulted loan;

FIG. 2B shows an embodiment of a due diligence group of loan states for processing a defaulted loan;

FIG. 3 shows an embodiment of a generic defaulted loan data table for processing a defaulted loan; and,

FIGS. 4 and 5A-5C schematically illustrate embodiments of methods for processing a defaulted loan.

### DETAILED DESCRIPTION

Illustrative embodiments will now be described to provide an overall understanding of the disclosed systems and methods. One or more examples of the illustrative embodiments are shown in the drawings. Those of ordinary skill in the art will understand that the disclosed systems and methods can be adapted and modified to provide systems and methods for other applications, and that other additions and modifications can be made to the disclosed systems and methods without departing from the scope of the present disclosure. For example, features of the illustrative embodiments can be combined, separated, interchanged, and/or rearranged to generate other embodiments. Such modifications and variations are intended to be included within the scope of the present disclosure.

Generally, the disclosed systems and methods relate to processing one or more defaulted loans. The disclosed systems and methods process defaulted loans based on associating the defaulted loans with one or more groups that include loan states, loan events that relate the loan states, and loan tasks that are associated with the loan events. At least some of the loan states, the loan events, and the loan tasks are at least partially based on governmental regulations. The processing groups can be configured for data collection and reporting and payment collection, reporting, and allocation. The processing groups can be capable of flexible processing. For example, in some embodiments, the processing groups can include knowledge-based schemes for reacting to loan events.

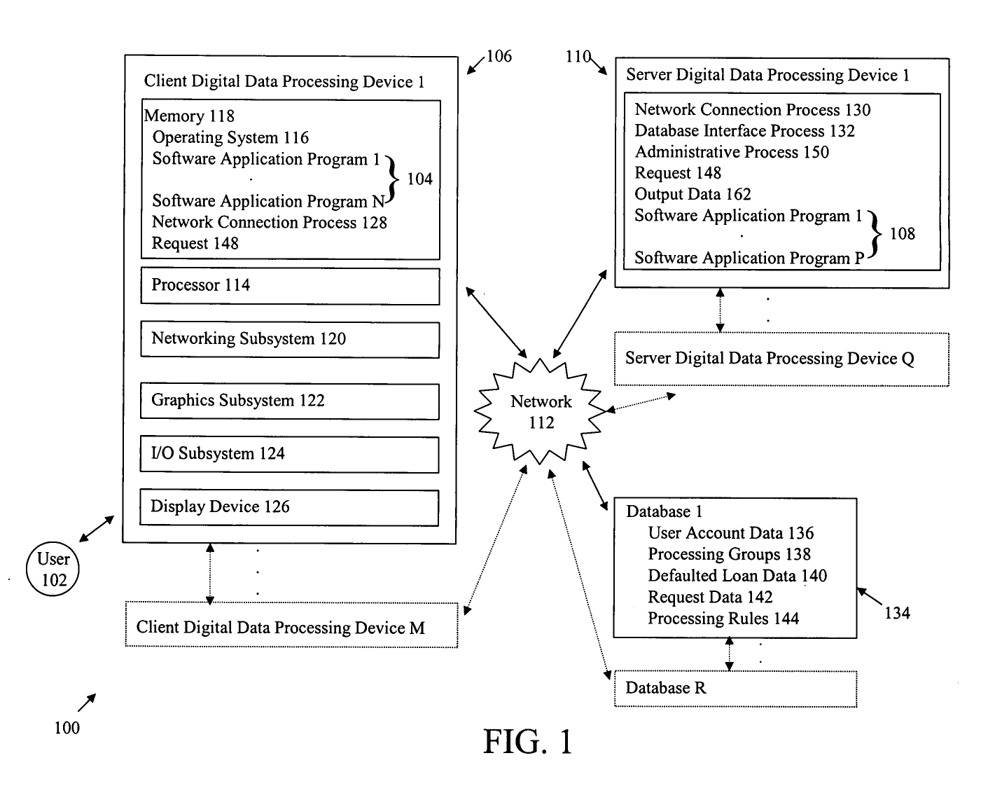

FIG. 1 schematically illustrates an exemplary system for processing defaulted loans. As shown in FIG. 1, the illustrated system 100 includes one or more client digital data processing devices 106 (“client”), one or more server digital data processing devices 110 (“server”), and one or more databases 134. The client 106, the server 110, and the database 134 communicate using one or more data communications networks 112 (“networks”).

In FIG. 1, the features in a digital data processing device are shown as residing in the client 106. Those of ordinary skill in the art will understand that one or more of the features of the client 106 can be present in the server 110.

Generally, references herein to a “client” and a “server” are used to differentiate two communicating devices and/or sets of processor instructions. References herein to a client and/or a server can thus be understood to be references to communications originating from a client and/or a server as these terms are understood by those of ordinary skill in the art. Such communications can be based on or otherwise initiated from one or more input devices (e.g., a keyboard, a stylus, a mouse, etc.) controlled by a user. Also, references herein to a client and/or a server can thus be understood to include one or more processor-controlled devices that act in a client-server (i.e., request-response) model, in which the client and the server can reside on the same processor-controlled device, and in which, based on perspective, the client can act as a server, and the server can act as a client.

As shown in the system 100 of FIG. 1, a user 102 desiring to process a defaulted loan can execute one or more software application programs 104 (such as, for example, an Internet browser and/or another type of application program capable of providing an interface to a defaulted loan processing program) residing on the client 106 to generate data messages that are routed to, and/or receive data messages generated by, one or more software application programs 108 (e.g., defaulted loan processing programs) residing on the server 110 via the network 112. A data message includes one or more data packets, and the data packets can include control information (e.g., addresses of the clients and the servers 106, 110, names/identifiers of the software application programs 104, 108, etc.) and payload data (e.g., data relevant to processing a defaulted loan, such as a request to apply a payment to a defaulted loan 148, and output data 162, such as a message indicating that the payment is applied).

The software application programs 104 can include one or more software processes (e.g., a calculation process/engine) executing within one or more memories 118 of the client 106. Similarly, the software application programs 108 can include one or more software processes executing within one or more memories of the server 110. The software application programs 108 can include one or more sets of instructions and/or other features that can enable the server 110 to process a defaulted loan. As described herein, the software application program 108 can include instructions for processing defaulted loan data 140 based on processing groups 138 and/or processing rules 144 to generate output data 162. The software application programs 104, 108 can be provided using a combination of built-in features of one or more commercially available software application programs and/or in combination with one or more custom-designed software modules. Although the features and/or operations of the software application programs 104, 108 are described herein as being executed in a distributed fashion (e.g., operations performed on the networked client and servers 106, 110), those of ordinary skill in the art will understand that at least some of the operations of the software application programs 104, 108 can be executed within one or more digital data processing devices that can be connected by a desired digital data path (e.g. point-to-point, networked, data bus, etc.).

The digital data processing device 106, 110 can include a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 refers to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof.

The instructions executed by a processor 114 represent, at a low level, a sequence of “0's” and “1's” that describe one or more physical operations of a digital data processing device. These instructions can be pre-loaded into a programmable memory (e.g., an electrically erasable programmable read-only memory (EEPROM)) that is accessible to the processor 114 and/or can be dynamically loaded into/from one or more volatile (e.g., a random-access memory (RAM), a cache, etc.) and/or non-volatile (e.g., a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to computing cash flows. The operating system 116 can support single-threading and/or multithreading, where a thread refers to an independent stream of execution running in a multi-tasking environment. A single-threaded system is capable of executing one thread at a time, while a multi-threaded system is capable of supporting multiple concurrently executing threads and can perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g., on a display device 126 and/or in a video memory). Inputs from the user 102 can be received via an input/output (I/O) subsystem 124 and routed to a processor 114 via an internal bus (e.g., system bus) for execution under the control of the operating system 116.

Similarly, a remote user (not shown) can interact with the digital data processing devices 106, 110 over the network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can include a networking subsystem 120 (e.g., a network interface card) to establish the communications link between the devices. The communications link interconnecting the digital data processing devices can include elements of a data communications network, a point to point connection, a bus, and/or another type of digital data path capable of conveying processor-readable data.

In one illustrative operation, the processor 114 of the client 106 executes instructions associated with the software application program 104 (including, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (including, for example, one or more menus, windows, and/or other visual objects) on the display device 126.

The network 112 can include a series of network nodes (e.g., the client and the servers 106, 110) that can be interconnected by network devices and wired and/or wireless communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a server node regardless of dissimilarities in the network topology (e.g., bus, star, token ring), spatial distance (e.g., local, metropolitan, wide area network), transmission technology (e.g., transfer control protocol/internet protocol (TCP/IP), Systems Network Architecture), data type (e.g., data, voice, video, multimedia), nature of connection (e.g., switched, non-switched, dial-up, dedicated, or virtual), and/or physical link (e.g., optical fiber, coaxial cable, twisted pair, wireless, etc.) between the originating and server network nodes.

FIG. 1 shows processes 128, 130, 132, and 150. A process refers to the execution of instructions that interact with operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, a network connection process 128, 130 refers to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended. A database interface process 132 refers to a set of instructions and other elements that enable the server 110 to access the database 134 and/or other types of data repositories to obtain access to, for example, user account data 136, processing groups 138, defaulted loan data 140, request data 142, and processing rules 144. The accessed information can be provided to the software application program 108 for further processing and manipulation. An administrative process 150 refers to a set of instructions and other features that enable the server 110 to monitor, control, and/or otherwise administer processing of a defaulted loan. For example, the administrative process 150 can a) maintain and update configuration, runtime, and/or session data for the one or more digital data processing devices 106, 110 and/or the software application programs 104, 108 executing on the devices 106, 110, b) provide buffer management, multi-threaded services, and/or data structure management, c) provide initialization parameters to the digital data processing devices 106, 110 and/or the software application programs 104, 108, d) manage groups of objects (e.g., groups of data elements stored on the digital data processing devices 106, 110 and/or stored or otherwise maintained in the database 134, groups of software application programs 104, 108, groups of users authorized to access software application programs 104, 108, groups of licenses, etc.), e) manage relationships between objects in response to messages communicated between the one or more digital data processing devices 106, 110, f) provide one or more support services (e.g., encryption/decryption, compression, path routing, message parsing, message format manipulation, etc.) to the digital data processing devices 106, 110, and/or g) provide load balancing based on, for example, processor usage/availability, network usage/availability, memory usage/availability, software application program usage/availability, message length, and/or message volume.

Those of ordinary skill in the art will recognize that, although the illustrated processes 128, 130, 132, and 150 and their features are described with respect to some embodiments, the illustrated processes and/or their features can be combined into one or more processes. One or more of the illustrated processes 128, 130, 132, and 150 can be provided using a combination of built-in features of one or more commercially available software application programs and/or in combination with one or more custom-designed software modules.

The databases 134 can be stored on a non-volatile storage medium or a device known to those of ordinary skill in the art (e.g., compact disk (CD), digital video disk (DVD), magnetic tape or disk, internal hard drive, external hard drive, random access memory (RAM), redundant array of independent disks (RAID), or removable memory device). As shown in FIG. 1, the databases 134 can be located remotely from the client 106. In some embodiments, the databases 134 can be located locally to the client 106 and/or can be integrated into the client 106. The databases 134 can include distributed databases. The databases 134 can include different types of data content and/or different formats for stored data content. For example, the databases 134 can include tables and other types of data structures.

User account data 136 includes data identifying one or more users of the system 100. Generally, user account data 136 includes data identifying the names, contact information, and login information of the users and user identifiers for the users. The contact information can be based on a wireless and/or a wired telecommunications network and can include one or more of email addresses, facsimile numbers, regular/postal (i.e., non-electronic) mail addresses, and telephone numbers. The login information can include usernames and associated passwords for accessing the system 100.

In some embodiments, users can share user accounts included in user account data 136. For example, two or more users can share one user account in user account data 136. In one such embodiment, the one user account can be associated with a group (e.g., a financial institution) and can be accessed by one or more members of the group (e.g., one or more loan officers of the financial institution).

In some embodiments, users can purchase data and/or services from the system 100. In such embodiments, user account data 136 can include account balances of the users. The account balances can include credits and/or debits associated with the user accounts, such as credits based on payments from users and debits based on purchases by users. Purchases can be made on an item-by-item basis. For example, in one such embodiment, a user can purchase data (e.g., defaulted loan data) based on providing a payment for the data. Alternatively and/or in combination, in some embodiments, data and/or services can be purchased on a subscription basis. For example, in one such embodiment, a user can purchase a subscription that allows the user to obtain an unlimited amount of data and/or services (e.g., defaulted loan processing services) during a time period for a flat price. In some embodiments, users can be offered a subscription based on their association with one or more group accounts in user account data 136 (e.g., the previously described group accounts for a financial institution).

Processing groups 138 include groups of loan states that represent different aspects of schemes for processing defaulted loans. Each group in processing groups 138 includes loan states, loan events that relate the loan states, and loan tasks that are associated with the loan events, in which at least some of the loan states, the loan events, and the loan tasks are at least partially based on one or more governmental regulations. The governmental regulations can include one or more federal governmental regulations and/or one or more state governmental regulations relating to defaulted loan processing. In some embodiments, each group can be associated with one or more parameters (collectively referred to herein as group criteria) for associating a defaulted loan with the group.

Generally, a defaulted loan can be processed based on associating the defaulted loan with a group from processing groups 138. For example, a defaulted loan associated with a group can be processed according to the loan states, loan events, and loan tasks in the group until the defaulted loan reaches the last state in the group and/or is associated with a different group. A defaulted loan can be associated with a different group of loan states based on a loan event (e.g., a loan event that relates a loan state in a group to a loan state in a different group) and/or a manual reassignment (i.e., a reassignment by a user of the system 100).

In some embodiments, a defaulted loan can be processed based on associating the defaulted loan with two or more groups. In some of such embodiments, the two or more groups can simultaneously and independently process the defaulted loan in parallel to each other according to the loan states, loan events, and loan tasks in the groups.

Generally, the groups in processing groups 138 can include processing components for performing data collection (e.g., collecting data regarding a borrower of a defaulted loan), data reporting (e.g., reporting data to data sources regarding the borrower), payment collection (e.g., collecting a payment from the borrower), payment reporting (e.g., reporting the payment from the borrower to data sources), and/or payment allocation (e.g., allocating the payment from the borrower to the defaulted loan and allocating the payment between remaining loan principal and accrued interest).

In some embodiments, the groups in processing groups 138 include processing components for performing activities (e.g., collection and reporting activities) related to one or more of a borrower repayment program, an administrative wage garnishment program, and a treasury offset program. As will be understood by those of ordinary skill in the art, a guarantor of a defaulted loan can seek payment on the loan from the borrower. Based on characteristics of the defaulted loan that include, among other things, the defaulted loan balance and a length of the default period, the guarantor can also seek payment on the loan from third parties. For example, the guarantor can seek payment from a federal treasury (e.g., the U.S. Treasury) that can intercept a borrower's federal tax refund, a state treasury that can intercept a borrower's state tax refund, and/or an employer who can garnish a borrower's wages. In some embodiments, therefore, one or more of the groups in processing groups 138 can be configured to request and otherwise process data from a payment program or a payment source. The data can include payment data, i.e., data related to payments on defaulted loans from the payment programs and sources, and processing data, i.e., data related to the eligibility of borrowers for participation in payment programs. The groups can be configured to request and otherwise process data based on legally defined schedules, e.g., schedules defined by federal and/or state regulations regarding defaulted loan processing.

In some embodiments, the groups in processing groups 138 include processing components for performing activities related to a due diligence program. As will be understood by those of ordinary skill in the art, laws can require guarantors to attempt to contact borrowers of defaulted loans to arrange payment of the defaulted loans. In some embodiments, therefore, one or more of the groups in processing groups 138 can be configured to request and otherwise process data according to a due diligence program. For example, some of the groups in processing groups 138 can be configured to contact borrowers and perform other tasks based on legally defined due diligence schedules.

As will be understood by those of ordinary skill in the art, the disclosed systems and methods are not limited to the previously described processing groups, and can include additional and/or different types of processing groups for processing defaulted loans. For example, in some embodiments, the processing groups 138 can include groups for performing activities based on legally defined schedules related to one or more of a dispute resolution program, a litigation program, a loan consolidation program, a loan rehabilitation program, a loan repurchase program, and a mandatory loan assignment program, as these terms are understood by those of ordinary skill in the art. Also for example, in some embodiments, the processing groups 138 can include groups designed or otherwise configured by one or more users of the system 100 for performing activities determined by the one or more users, such as activities related to a customized, i.e., user-specific, payment program.

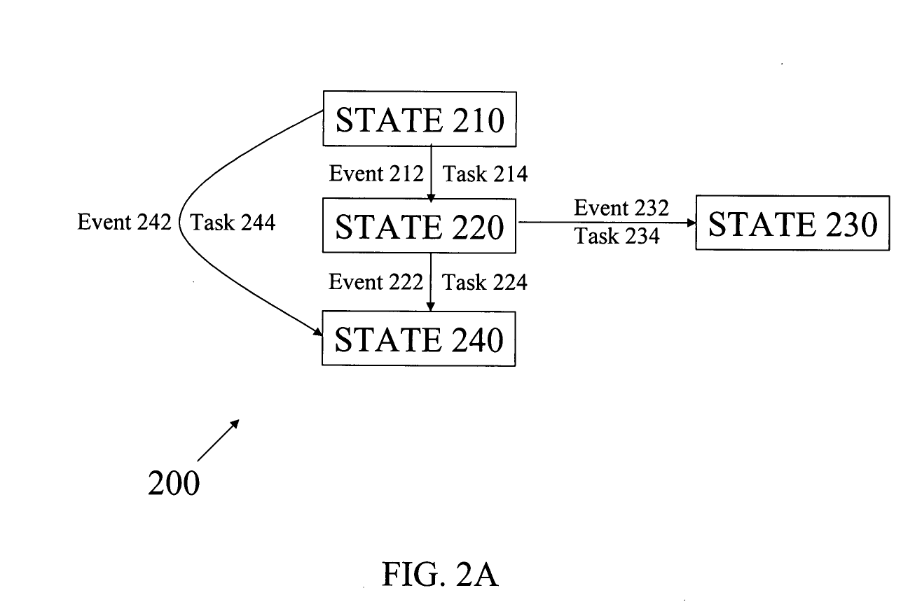

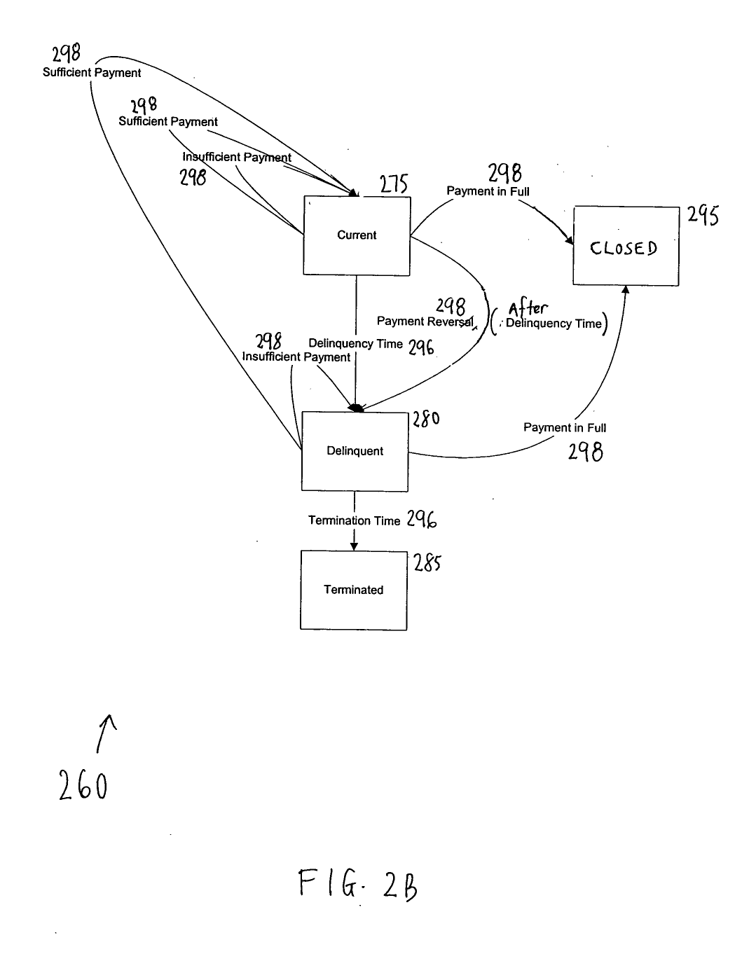

FIG. 2A shows an embodiment of a generic group of loan states. As shown in FIG. 2, the group 200 includes loan states 210, 220, 230, and 240, loan events 212, 222, 232, and 242, and loan tasks 214, 224, 234, and 244. The group 200 represents a processing component of a scheme for processing a defaulted loan. The loan states 210, 220, 230, and 240 represent processing states for defaulted loans, the loan events 212, 222, 232, and 242 represent conditions that cause transitions between the loan states 210, 220, 230, and 240, and the loan tasks 214, 224, 234, and 244 represent processing associated with the loan events 212, 222, 232, and 242. The loan events 212, 222, 232, and 242 include synchronous events, i.e., events that are based on time (e.g., a number of days) and/or asynchronous events, i.e., events that are based on asynchronous occurrences (e.g., a receipt of payment data and/or processing data regarding a defaulted loan from a payment source, such as an administrative wage garnishment program). In some embodiments, one or more loan events can relate two different groups of loan states to each other. For example, in one embodiment, a loan event can relate a loan state in a first group of loan states to a loan state in a second different group of loan states. The first and second groups can represent different aspects of processing defaulted loans. The loan tasks 214, 224, 234, and 244 are performed based on transitions between the loan states. For example, loan task 214 is performed based on a transition from loan state 210 to loan state 220. As will be understood by those of ordinary skill in the art, the type and number of states, events, and tasks in group 200 can vary based on the type of processing component that group 200 represents.

FIG. 2B shows an embodiment of a due diligence group of loan states. As shown in FIG. 2B, the due diligence group 260 includes loan states 275, 280, 285, and 295 labeled current, delinquent, terminated, and closed, and synchronous loan events 296 and asynchronous loan events 298 that relate the loan states to each other.

In some embodiments, the loan tasks associated with the groups in processing groups 138 include applying a payment to a defaulted loan, determining whether a borrower associated with a defaulted loan is eligible for a payment program (e.g., an offset program of a treasury), generating a communication to a borrower and/or a non-borrower associated with a defaulted loan, and requesting a payment for the defaulted loan from a payment source. As will be understood by those of ordinary skill in the art, the disclosed systems and methods are not limited to such loan tasks, and can include additional and/or different loan tasks for processing defaulted loans.

Defaulted loan data 140 includes one or more defaulted loan data files. As used herein, a data file can be understood to include a file having types and formats of data known to those of ordinary skill in the art. In some embodiments, a data file can be understood to include one or more portions of a data file. For example, in some embodiments, a data file can be understood to include data objects within a data file, such as attachments, records, and data rows and tables (e.g., data rows and tables in a structured query language (SQL) database file), with such examples being provided for illustration and not limitation.

Each defaulted loan data file includes data relating to one or more defaulted loans. The one or more defaulted loans can include a group of related defaulted loans, such as, but not limited to, defaulted loans that are associated with the same borrower and defaulted loans that are associated with the same payment program (e.g., a federal treasury offset program). Each defaulted loan data file can be associated with a defaulted loan identifier identifying the one or more defaulted loans and one or more user identifiers that identify one or more respective users of the system 100 having access rights (e.g., read and/or write access rights) to the defaulted loan data file. A defaulted loan identifier can include an alphabetical, numeric, and/or alphanumeric identifier. For example, a defaulted loan identifier can include an identifier assigned or otherwise provided to a borrower of a defaulted loan by a federal and/or a state governmental entity, e.g., a U.S. Social Security Number (SSN). In some embodiments, a defaulted loan identifier can be generated by the system 100 based on applying one or more data compression and/or data encryption schemes to data identifying the borrower. For example, a defaulted loan identifier can include a compressed and/or an encrypted borrower SSN. Alternatively and/or in combination, in some embodiments, a defaulted loan identifier can be selected or otherwise provided by a user of the system 100.

In some embodiments, each defaulted loan data file includes one or more characteristics of a borrower of one or more defaulted loans. The characteristics can include a borrower name, a borrower identifier (such as, but not limited to, an SSN), a borrower address, and/or other data specific to a borrower as understood by those of ordinary skill in the art (e.g., a length of time during which a borrower has resided at a borrower address, a borrower's employment status, a borrower's salary, a borrower's mental and/or physical disability status, etc.).

Generally, each defaulted loan data file includes one or more characteristics of one or more defaulted loans. The characteristics can include a monetary balance (e.g., an original monetary balance (i.e., face value) of the loan and a current monetary balance (i.e., the remaining amount of the loan to be repaid)), an interest rate, an accrued interest, a legal status of the loan (e.g., consolidated, current, deferred, delinquent, disputed, rehabilitated, repurchased, etc.), and/or a history of activity (e.g., dates, types, and amounts of payments received and dates and types of correspondence sent and/or received from a borrower and/or a non-borrower).

Generally, each defaulted loan data file also includes data identifying the processing status of one or more defaulted loans. This data identifies the one or more processing groups that are associated with the one or more defaulted loans and the loan states, loan events, and loan tasks included in the one or more processing groups. In some embodiments, data identifying the processing status of the one or more defaulted loans can be represented in the form of one or more data tables.

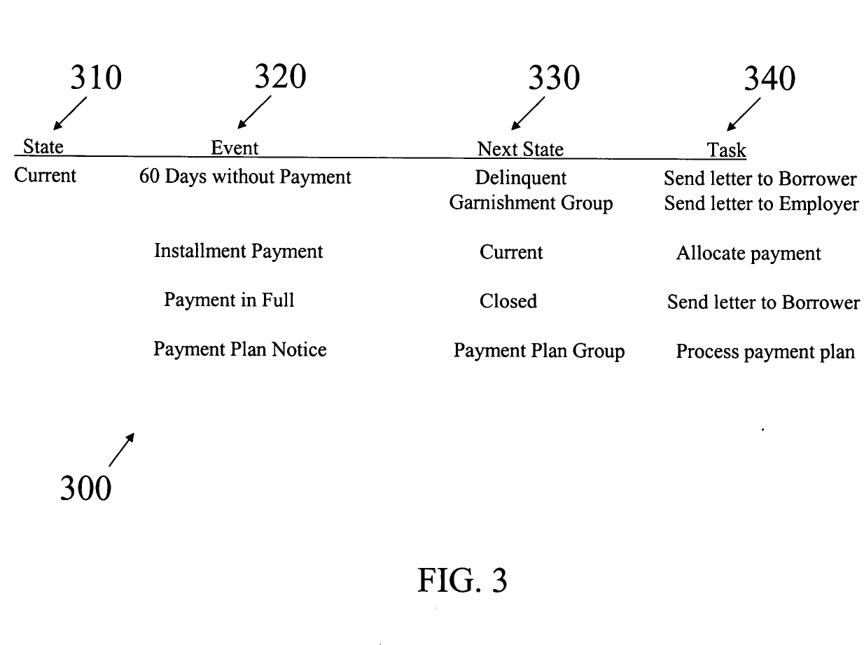

FIG. 3 shows an embodiment of a generic defaulted loan data table associated with a defaulted loan. The data table 300 shown in FIG. 3 includes data for a defaulted loan that is associated with a due diligence group. The data table 300 shows the current loan state 310 for the loan, events 320 that relate the current loan state 310 to other, i.e., next, loan states 330, and tasks 340 that are associated with the events 330. As shown in FIG. 3, an event can be associated with one or more tasks. For example, as shown in FIG. 3, the event “60 days without payment” is associated with two tasks, specifically, sending a letter to the borrower of the defaulted loan and sending a letter to the employer of the borrower to institute an administrative wage garnishment program. As also shown in FIG. 3, an event can cause a defaulted loan to transition to two or more states associated with different groups in processing groups 138. For example, the event “60 days without payment” causes the defaulted loan to transition to the delinquent state in the due diligence group and to an entry state in a administrative wage garnishment group. Based on the event, the defaulted loan can be processed in parallel by the due diligence group and the administrative wage garnishment group.

Request data 142 includes data based on one or more requests (e.g., request 148) provided by one or more users of the system 100. The requests can include requests for processing defaulted loans (e.g., requests for applying a payment to a defaulted loan). The stored requests can be associated with defaulted loan identifiers, user identifiers (e.g., usernames), alphanumeric tracking identifiers, status data (e.g., data indicating the status of the request, such as pending or completed, etc.), and time data (e.g., time of receipt, time of status, etc.). In some embodiments, requests can be stored and subsequently processed by one or more queues associated with the server 110, as described herein.

Processing rules 144 include rules for associating defaulted loans with one or more of the groups of loan states included in processing groups 138 and with one or more of the loan states included in the one or more groups. As previously described, in some embodiments, each group of loan states in processing groups 138 includes group criteria for associating a defaulted loan with the group. For example, the group criteria for associating a defaulted loan with an administrative wage garnishment group can include a delinquency status of more than three months and a defaulted loan balance greater than $5000. In some of such embodiments, therefore, processing rules 144 can include rules for comparing one or more characteristics associated with a defaulted loan with one or more group criteria. The characteristics associated with the defaulted loan can include one or more of the previously described characteristics, e.g., legal status, length of default period, and monetary balance. Alternatively and/or in combination, the characteristics associated with the defaulted loan can include one or more characteristics of the borrower, e.g., salary, employment status, physical and/or mental disability status, etc.

As previously described, the disclosed systems and methods can process a defaulted loan based on a request from a user of system 100 shown in FIG. 1 (e.g., a request to apply a payment to a defaulted loan). Graphical user interfaces that facilitate processing of defaulted loans can include one or more check boxes, one or more response boxes, one or more radio buttons, one or more pull-down menus, one or more icons, one or more other visual objects, and/or other items known by those of ordinary skill in the art.

In one illustrative operation and with reference to FIG. 1, the software application program executing within the memory 118 of the client 106 can detect a request 148 to display a group included in processing groups 138. In response to the request 148, the software application program 104 can instruct the graphics subsystem 122 (via the processor 114) to display the processing group. The user 102 can then modify one or more features of the displayed processing group. For example, the user can modify a loan state, a loan event, and/or a loan task in the displayed group. Generally, the disclosed systems and methods permit loan states, loan events, and loan tasks to be removed, replaced, and/or modified by a user of the system 100. Changes to a processing group or to a characteristic of a processing group can affect the processing of defaulted loans that are being processed based on the processing group.

In another illustrative operation and with reference to FIG. 1, the software application program executing within the memory 118 of the client 106 can detect a request 148 to process a defaulted loan (e.g., a request to apply a payment to a defaulted loan) from the user 102 by, for example, receiving an indication from the I/O subsystem 124 that detected a mouse click, a keyboard entry, and/or another input event initiated by the user 102. In response to the request 148, the software application program 104 can instruct the graphics subsystem 122 (via the processor 114) to display one or more options for selection by the user and/or one or more requests for information from the user. The user 102 can then initiate another input event corresponding to, for example, an entry of a defaulted loan identifier and/or a borrower identifier. Similar sequences of input events and detections by the software application program 104 can enable the user 102 to specify one or more additional parameters that define a defaulted loan processing request of interest. The request 148 and its associated parameters selected by the user 102 can be maintained in the memory 118 of the client 106 prior to transmission to the server 110 via the network 112. The software application program 104 can apply one or more rules to the request 148 to reduce the occurrence of erroneous requests. One or more of these rules can be contained in memory 118. Alternatively and/or in combination, the software application program 104 can access one or more of these rules from the database 134 via the network 112. As will be understood by those of ordinary skill in the art, in one embodiment, the software application program 104 can apply one or more data validation rules to the request 148 to determine the validity of the parameters associated with the request 148 and notify the user 102 of errors.

With continuing reference to FIG. 1, the software application program 104 can instruct the network connection process 128 of the client 106 to transmit the parameters associated with the request 148 selected by the user 102 to a calculation process or another software process associated with the software application program 108 executing on the server 110 by, for example, encoding, encrypting, and/or compressing the selected request 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108. The software application program 108 can process the request 148 by, for example, applying one or more processing groups 138 and/or one or more processing rules 144 to defaulted loan data 140.

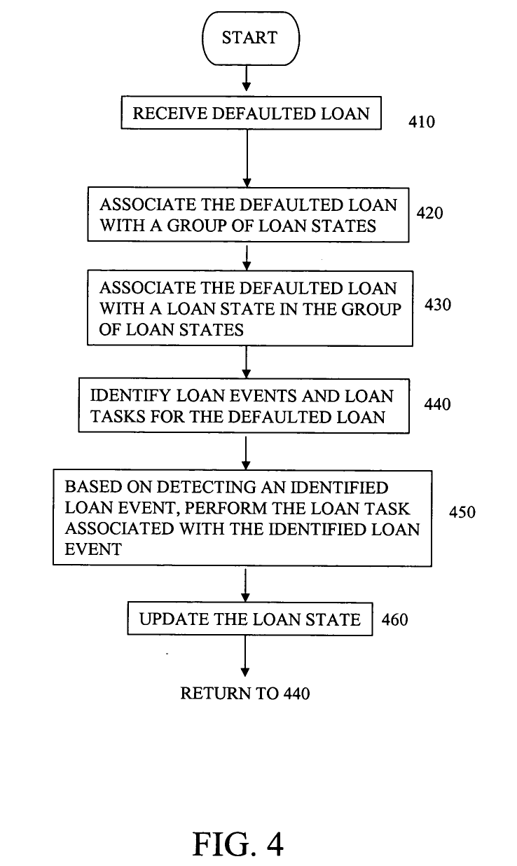

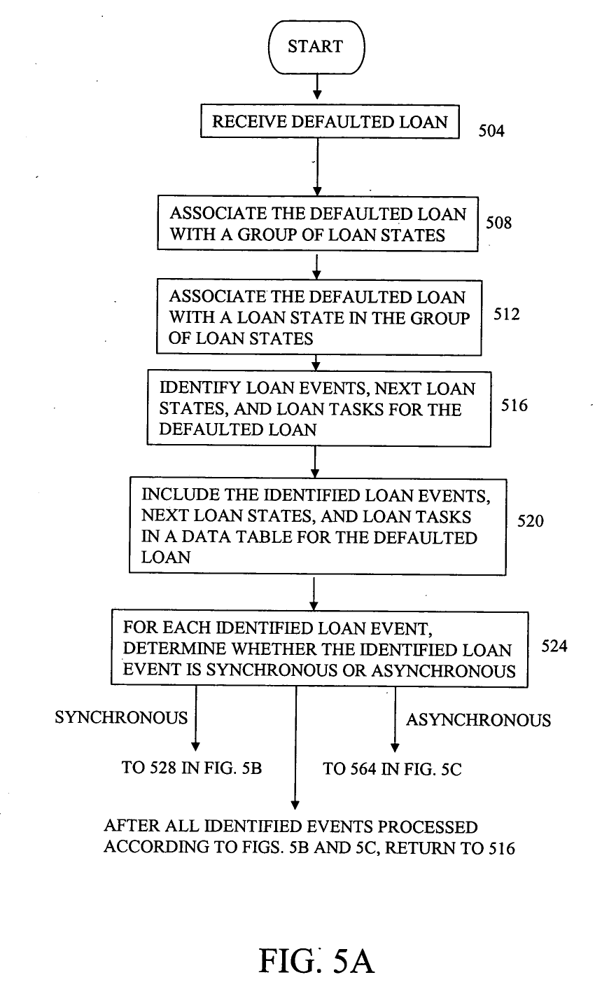

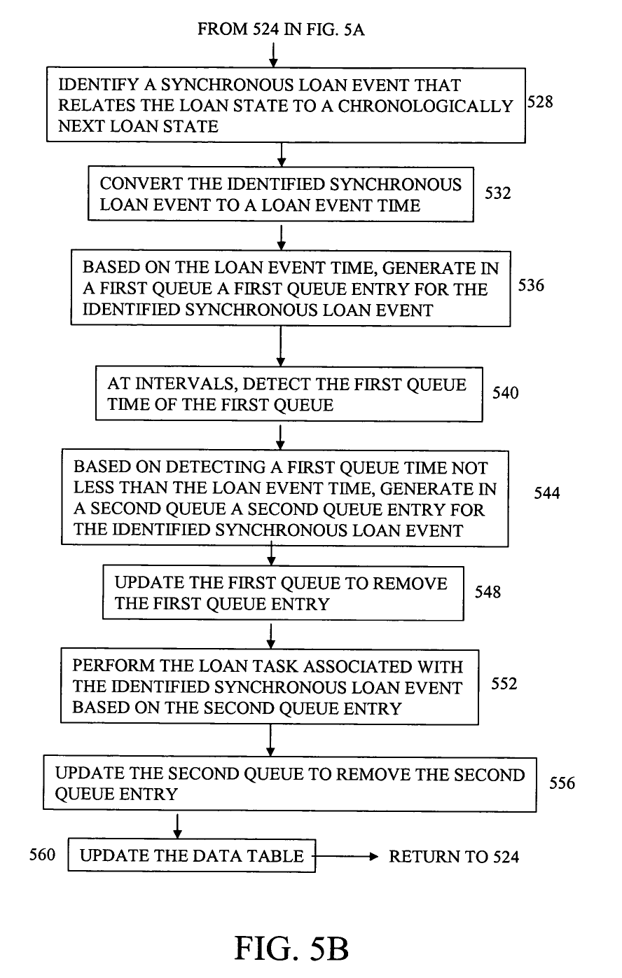

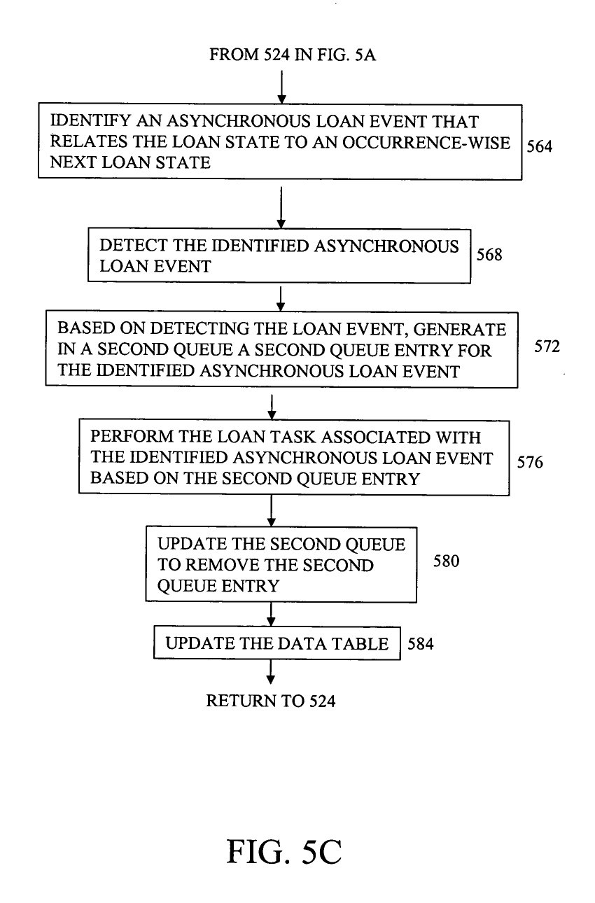

FIGS. 4 and 5A-5C schematically illustrate embodiments of methods for processing a defaulted loan in system 100. As will be understood by those of ordinary skill in the art, the disclosed systems and methods are not limited to the embodiments shown in FIGS. 4 and 5A-5C and can process one or more defaulted loans based on one or more flow elements different than and/or additional to those shown in FIGS. 4 and 5A-5C.

As previously described, a defaulted loan can be associated with and independently processed by two or more processing groups based on the loan states, loan events, and loan tasks in the groups. For purposes of illustration, the flow elements of FIGS. 4 and 5A-5C are described with respect associating a defaulted loan with one group of loan states. Those of ordinary skill in the art will understand that a defaulted loan can be associated with two or more groups of loan states and subsequently processed based on performing one or more of the flow elements of FIGS. 4 and 5A-5C two or more times.

FIG. 4 schematically illustrates an overview of an embodiment of a method for processing a defaulted loan. As shown in FIG. 4, a defaulted loan is received at a server (e.g., server 110) in system 100 (410 in FIG. 4). The defaulted loan can be received from a user 102 interacting with a client (e.g., client 106). The defaulted loan can include data identifying the defaulted loan (e.g., a defaulted loan identifier), data identifying a borrower associated with a defaulted loan (e.g., a borrower name and address), and one or more characteristics of the defaulted loan (e.g., a monetary balance, an interest rate, a length of a default period, etc.).

Based on the defaulted loan, the server 110 (e.g., a software application program 108 residing on server 110) identifies a group of loan states from processing groups 138 to which to associate the defaulted loan (420 in FIG. 4). For example, with reference to FIG. 3, the server 110 can identify the due diligence group. In some embodiments, the server 110 identifies the group of loan states based on the processing rules 144. For example, in some embodiments, based on the processing rules 144, the server 110 compares one or more characteristics of the defaulted loan with one or more group criteria and associates the defaulted loan with the group of loan states whose criteria match the defaulted loan's characteristics.

Alternatively and/or in combination, in some embodiments, the server 110 can query the client 106 (i.e., the user 102 via the client 106) to select and/or otherwise provide a group of loan states to which to associate the defaulted loan. For example, in some embodiments, the server 110 can provide one or more groups of loan states for selection by the client 106.

Based on associating the defaulted loan with a group of loan states, the server 110 identifies a loan state in the group of loan states to which to associate the defaulted loan (430 in FIG. 4). For example, with reference to FIG. 3, the server 110 can associate the defaulted loan with the current loan state. In some embodiments, the server 110 associates the defaulted loan with the chronologically first loan state in the group of loan states. Alternatively, in some embodiments, the server 110 associates the defaulted loan with a loan state in the group based on the processing rules 144 and schemes similar to those described herein with respect to element 420 in FIG. 4. For example, in some embodiments, the server 110 compares one or more characteristics of the defaulted loan (e.g., a legal status, such as current and past due) with one or more features describing the loan states in the group and associates the defaulted loan with the state whose features match the characteristics of the defaulted loan. Alternatively and/or in combination, in some embodiments, the server 110 queries the client 106 (i.e., the user 102) to select and/or otherwise provide the loan state to which to associate the defaulted loan.

Based on associating the defaulted loan with a processing group and a loan state in the processing group, the server 110 identifies loan events and associated loan tasks for the defaulted loan (440 in FIG. 4). The server 110 identifies loan events that relate the loan state to other loan states, i.e., other loan states in the group and/or loan states in other groups, and loan tasks that are associated with the loan events. For example, with reference to FIG. 3, the server 110 can identify the loan event 60 days without payment and the associated loan tasks send letter to borrower and send letter to employer.

Subsequently, based on detecting an identified loan event that relates the loan state to another loan state, the server 110 performs the loan task associated with the loan event (450 in FIG. 4). For example, with reference to FIG. 3, based on detecting the loan event 60 days without payment, the server 110 sends a letter to the borrower advising him of his delinquent status. The server 110 detects a synchronous loan event based on detecting a passage of time, e.g., a number of days, from a reference time, such as the time associated with a loan state. The server 110 detects an asynchronous loan event based on detecting an asynchronous occurrence, e.g., receiving payment data and/or processing data from a payment source regarding a defaulted loan. Additionally, the server 110 updates the loan state to be the other loan state, i.e., updates the present loan state to be the loan state related to the present loan state by the identified event (460 in FIG. 4), and iteratively returns to identifying loan events that relate the loan state, i.e., the new present loan state, to other loan states (440 in FIG. 4). For example, with continuing reference to FIG. 3, based on detecting the loan event 60 days without payment, the server 110 updates the loan state from the current loan state to the delinquent loan state, and identifies loan events that relate the delinquent loan state to other loan states.

FIGS. 5A-5C schematically illustrate an embodiment of a method for processing synchronous and asynchronous loan events by using a defaulted loan data table, a first queue, and a second queue. As shown in FIG. 5A, a request for processing a defaulted loan is received (504 in FIG. 5A) and the server 110 associates the defaulted loan with a group of loan states (508 in FIG. 5A), associates the defaulted loan with a loan state in the group (512 in FIG. 5A), and identifies loan events, next loan states, and loan tasks for the state and group to which the defaulted loan is associated (516 in FIG. 5). As also shown in FIG. 5A, the server 110 includes the identified loan events, the next loan states, and the loan tasks in a defaulted loan data table (520 in FIG. 5). The defaulted loan data table can be similar to data table 300 shown in FIG. 3. In some embodiments, the server 110 generates entries in the data table only for events that directly connect the present loan state (i.e., the loan state to which the defaulted loan is presently associated) to another loan state, i.e., only for events that cause a transition from the present loan state to another loan state without an intervening loan state. In such embodiments, the data table for the defaulted loan represents the present loan state of the defaulted loan, loan events that relate the present loan state to one or more next loan states, the next loan states, and the loan tasks associated with the loan events. As used herein, the term next loan state refers to a time-wise next loan state (i.e., a chronologically next loan state) in the context of a synchronous loan event and an occurrence-wise next loan state in the context of an asynchronous loan event. For each event in the data table, the server 110 determines whether the event is synchronous or asynchronous (524 in FIG. 5A). Based on the event being synchronous, the server 110 processes the event according to FIG. 5B. Alternatively, based on the event being asynchronous, the server 110 processes the event according to FIG. 5C. After all identified events in the data table are processed according to FIGS. 5B and 5C, the server 110 returns to element 516 in FIG. 5A.

As shown in FIG. 5B, the server 110 identifies a synchronous loan event that relate the present loan state to a chronologically next loan state (528 in FIG. 5B). For example, with reference to FIG. 3, the server 110 identifies the loan event 60 days without payment. The server 110 converts the synchronous loan event to a loan event time (532 in FIG. 5B). In some embodiments, the server 110 converts the synchronous loan event to a loan event time based on the quantity of time represented by the synchronous loan event (e.g., a number of days) and reference time, i.e., the time of the loan state. For example, in some of such embodiments, the server 110 can convert the synchronous loan event to a loan event time based on adding the quantity of time represented by the synchronous loan event to the reference time of the loan state.

Based on the loan event time, the server 110 generates a first queue entry in a first queue for the identified synchronous loan event (536 in FIG. 5B). The first queue can be understood to be a next visit or holding queue that includes time-based entries for synchronous events associated with the defaulted loans being processed by the system 100. The first queue entry includes at least the loan event time. In some embodiments, the first queue entry includes data that represents and/or otherwise identifies one or more of the defaulted loan, the present loan state, the identified synchronous loan event, and the loan task associated with the identified synchronous loan event. At intervals (e.g., regular or periodic intervals and/or irregular intervals), the server 110 and/or the first queue detects the time of the first queue (otherwise referred to as the first queue time) (540 in FIG. 5B).

Based on detecting a first queue time that is greater than and/or equal to the loan event time, the server 110 generates a second queue entry in a second queue (544 in FIG. 5B). As will be understood by those of ordinary skill in the art, a first queue time that is greater than or equal to the loan event time indicates an occurrence of the synchronous loan event. The second queue can be understood to be an execution queue that includes entries for execution by the server 110. As such, the second queue entry includes data that represents and/or otherwise identifies one or more of the defaulted loan, the loan state, the identified synchronous loan event, and the loan task associated with the identified synchronous loan event. Thereafter, the server 110 updates the first queue to remove the first queue entry for the synchronous loan event (548 in FIG. 5B), performs the loan task associated with the synchronous loan event based on the second queue entry (552 in FIG. 5B), updates the second queue to remove the second queue entry based on performing the loan task (556 in FIG. 5B), updates the data table (560 in FIG. 5B) (i.e., updates the loan state to be the chronologically next loan state), and returns to identifying loan events and loan tasks for the defaulted loan based on the updated loan state (516 in FIG. 5A).

As shown in FIG. 5C, the server 110 identifies an asynchronous loan event that relates the present loan state to an occurrence-wise next loan state (564 in FIG. 5C). The server 110 detects the identified asynchronous loan event (568 in FIG. 5C). For example, as previously described, the server 110 detects the asynchronous loan event by receiving payment data and/or processing data regarding the defaulted loan from a payment plan and/or a payment source. Based on detecting the identified asynchronous loan event, the server 110 generates a second queue entry for the loan event in the second queue, i.e., the same second queue as described with respect to FIG. 5B (572 in FIG. 5C). Thereafter, the server 110 performs the loan task associated with the asynchronous loan event based on the second queue entry (576 in FIG. 5B), updates the second queue to remove the second queue entry based on performing the loan task (580 in FIG. 5B), updates the data table (584 in FIG. 5B) (i.e., updates the loan state to be the occurrence-wise next loan state), and returns to identifying loan events and loan tasks for the defaulted loan based on the updated loan state (516 in FIG. 5A).

As previously described, the server 110 can detect an asynchronous loan event based on receiving from a payment source payment data and/or processing data regarding a defaulted loan. Generally, the server 110 is configured to communicate with one or more payment sources. For example, in some embodiments, the server 110 is configured to communicate via the Internet and/or one or more intranets with the U.S. Department of the Treasury, the U.S. Department of Education, one or more state treasuries (e.g., the Massachusetts Department of Revenue), one or more employers who participate in administrative wage garnishment programs, and/or one or more borrowers. In some of such embodiments, the server 110 receives data from one or more of the payment sources and updates one or more defaulted loan data tables based on the received data. For example, the server 110 can receive data from the U.S. Department of Education regarding the eligibility of borrowers for participation in payment programs (such as, but not limited to, loan consolidation and loan rehabilitation programs). Based on such data, the server 110 can update data tables for corresponding defaulted loans to, for example, associate the defaulted loans with different loan states in a processing group, associate the defaulted loans with additional and/or different processing groups, and identify additional and/or different loan events for the processing groups.

As previously described, the server 110 is configured to perform loan tasks associated with loan events. As will be understood by those of ordinary skill in the art, some loan tasks (referred to herein as first type loan tasks) can be performed by the server 110 without cooperation from one or more users of the system 100, while other loan tasks (referred to as herein as second type loan tasks) can be performed only in cooperation with one or more users of the system 100. First type loan tasks can include applying payments to defaulted loans, generating letters to borrower and/or non-borrowers, and determining eligibility of a borrower for a payment program. Second type loan tasks can include making telephone calls to borrowers and/or non-borrowers, generating templates for letters to borrowers and/or non-borrowers, and performing manual adjustments to data included in one or more defaulted loan data files.

In some embodiments, the server 110 performs a first type loan task based on executing one or more commercially available software application programs and/or one or more custom-designed software modules. For example, in some embodiments, the server 110 generates letters to borrowers and/or non-borrowers based on applying a mail merge software program to one or more template letters (such as template letters provided by a user of the system 100).

In some embodiments, the server 110 performs a second type loan task based on providing one or more portions of the loan task to one or more users of the system 100. For example, in some embodiments, the server generates one or more work items for one or more users of the system 100 based on one or more second queue entries in the second queue. In some of such embodiments, the server 110 generates sets or schedules of work items to be performed by individual users of the system 100 (e.g., individual loan administrators).

As previously described, a user of the system 100 can transmit a request to the server 110 to process a defaulted loan. For example, a loan administrator can request that an adjustment be made to a loan event for a defaulted loan. Generally, the server 110 generates second queue entries based on requests from users of the system 100. In some embodiments, the server 110 generates second queue entries for the requests so that they will be preferentially executed with respect to other second queue entries.

As previously described, the disclosed systems and methods process defaulted loans based on associating the defaulted loans with processing groups. In some embodiments, the disclosed systems and methods include first and second processing modules, in which the first processing module processes defaulted loans based on the processing groups as described herein and the second processing module processes defaulted loans based on one or more non-processing-group-based schemes known to those of ordinary skill in the art. In some of such embodiments, the first module can represent a defaulted loan manager module that is responsible for data collection and reporting, and the second module can represent an accounts receivable portion that is responsible for payment allocation (e.g., allocation of received payments on defaulted loans between principal and interest).

Accordingly, systems and methods for processing defaulted loans are disclosed herein. The disclosed systems and methods provide improved efficiency and reliability in processing defaulted loans because they process defaulted loans based on data from multiple independent data sources. The disclosed systems and methods also provide improved efficiency in processing defaulted loans because they simultaneously process defaulted loans according to different processing aspects (e.g., data collection and reporting aspects and payment collection and reporting aspects).

The systems and methods described herein are not limited to a hardware or software configuration; they can find applicability in many computing or processing environments. The systems and methods can be implemented in hardware or software, or in a combination of hardware and software. The systems and methods can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic tape or disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

Unless otherwise provided, references herein to memory can include one or more processor-readable and -accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application.

Unless otherwise provided, references herein to a/the processor and a/the microprocessor can be understood to include one or more processors that can communicate in stand-alone and/or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application-specific integrated circuit, and/or a task engine, with such examples provided for illustration and not limitation.

Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims.

For example, the disclosed systems and methods are not limited to processing defaulted loans, but can process other types of data, such as data related to business, engineering, finance, law, and science.

Also for example, the disclosed systems and methods are not limited to a graphical presentation of processing groups. The disclosed processing groups can be graphically presented in different forms that preserve relationships between loan states, loan events, and loan tasks.

Accordingly, the systems and methods described herein are not to be limited to the embodiments described herein, can include practices other than those described, and are to be interpreted as broadly as allowed under prevailing law.

1. A method for processing a defaulted loan, the method comprising:
providing a group of loan states, loan events that relate the loan states, and loan tasks that are associated with the loan events, in which at least some of the loan states, the loan events, and the loan tasks are at least partially based on at least one governmental regulation,
associating the defaulted loan with a loan state,
identifying a loan event that relates the loan state to another loan state, and
based on detecting the identified loan event, performing the loan task associated with the identified loan event.

2. The method of claim 1, further comprising:
updating the loan state, and
iteratively returning to identifying a loan event that relates the loan state to another loan state.

3. The method of claim 1, wherein the identified loan event includes a synchronous loan event that relates the loan state to a chronologically next loan state.

4. The method of claim 3, further comprising:
converting the identified synchronous loan event to a loan event time, and
generating in a first queue a first queue entry that includes data representing the loan event time and at least one of: the defaulted loan, the loan state, the identified synchronous loan event, and the loan task associated with the identified synchronous loan event.

5. The method of claim 4, wherein detecting the identified loan event includes:
detecting a first queue time for the first queue that is not less than the loan event time.

6. The method of claim 5, further comprising:
based on detecting a first queue time for the first queue that is not less than the loan event time, generating in a second queue a second queue entry that includes data representing at least one of: the defaulted loan, the loan state, the identified synchronous loan event, and the loan task associated with the identified synchronous loan event.

7. The method of claim 6, further comprising:
based on detecting a first queue time for the first queue that is not less than the loan event time, updating the first queue to remove the first queue entry.

8. The method of claim 6, further comprising:
based on performing the loan task, updating the second queue to remove the second queue entry.

9. The method of claim 1, wherein the identified loan event is asynchronous and detecting the identified asynchronous event includes:
receiving from a payment source at least one of: payment data and processing data related to the defaulted loan.

10. The method of claim 9, wherein the payment source includes at least one of: an administrative wage garnishment program, a borrower associated with the defaulted loan, a federal treasury offset program, a loan consolidation program, a loan rehabilitation program, a loan repurchase program, and a state treasury offset program.

11. The method of claim 9, wherein the processing data includes data related to an eligibility of a borrower associated with the defaulted loan for a payment program of the payment source.

12. The method of claim 9, further comprising:
based on detecting the identified asynchronous loan event, generating in a second queue a second queue entry including data representing at least one of: the defaulted loan, the identified asynchronous loan event, and the loan task associated with the identified asynchronous loan event.

13. The method of claim 12, further comprising:
based on performing the loan task, updating the second queue to remove the second queue entry.

14. The method of claim 1, wherein the at least one governmental regulation includes at least one of: at least one federal governmental regulation and at least one state governmental regulation.

15. The method of claim 1, wherein associating the defaulted loan with a loan state includes:
based on at least one characteristic of the defaulted loan, associating the defaulted loan with a loan state.

16. The method of claim 15, wherein the at least one characteristic includes at least one of: a legal status, a length of a default period, a monetary balance, and a characteristic of a borrower associated with the defaulted loan.

17. The method of claim 1, wherein the loan task includes at least one of: applying a payment to the defaulted loan, determining whether a borrower associated with the defaulted loan is eligible for a payment program of a payment source, generating a communication to a borrower associated with the defaulted loan, generating a communication to a non-borrower associated with the defaulted loan, and requesting a payment for the defaulted loan from a payment source.

18. The method of claim 1, wherein identifying includes:
identifying a loan event that relates the loan state to a loan state in a different group of loan states.

19. The method of claim 18, further comprising:
updating the loan state to be the loan state in the different group of loan states.

20. The method of claim 19, further comprising:
iteratively returning to identifying a loan event that relates the loan state to another loan state.

21. The method of claim 18, wherein the different groups of loan states are associated with different aspects of processing the defaulted loan, in which the different aspects relating to at least one of: due diligence data collection and reporting and payment collection and allocation.

22. A system for processing a defaulted loan, the system comprising:
a group of loan states, loan events that relate the loan states, and loan tasks that are associated with the loan events, in which at least some of the loan states, loan events, and loan tasks are at least partially based on at least one governmental regulation, and
a digital data processing device in communication with the group of loan states and configured to:
associate the defaulted loan with a loan state,
identify a loan event that relates the loan state to another loan state, and
based on detecting the identified loan event, perform the loan task associated with the identified loan event.

23. The system of claim 22, wherein the digital data processing device is further configured to:
update the loan state, and
iteratively return to identifying a loan event that relates the loan state to another loan state.

24. The system of claim 22, wherein the identified loan event includes a synchronous loan event that relates the loan state to a chronologically next loan state.

25. The system of claim 24, further comprising:
a first queue,
wherein the digital data processing device is further configured to:
convert the identified synchronous loan event to a loan event time, and
generate in the first queue a first queue entry that includes data representing the loan event time and at least one of: the defaulted loan, the loan state, the identified synchronous loan event, and the loan task associated with the identified synchronous loan event.

26. The system of claim 25, wherein the digital data processing device is configured to:
detect a first queue time for the first queue that is not less than the loan event time.

27. The system of claim 26, further comprising:
a second queue,
wherein the digital data processing device is further configured to:
generate in the second queue a second queue entry that includes data representing at least one of: the defaulted loan, the loan state, the identified synchronous loan event, and the loan task associated with the identified synchronous loan event based on detecting a queue time for the first queue that is not less than the loan event time.

28. The system of claim 22, wherein the identified loan event is asynchronous and the digital data processing device is configured to:
receive from a payment source at least one of: payment data and processing data related to the defaulted loan.

29. The system of claim 28, wherein the payment source includes at least one of: an administrative wage garnishment program, a borrower associated with the defaulted loan, a federal treasury offset program, a loan consolidation program, a loan rehabilitation program, a loan repurchase program, and a state treasury offset program.

30. The system of claim 28, wherein the processing data includes data related to an eligibility of a borrower associated with the defaulted loan for a payment program of the payment source.

31. The system of claim 22, wherein the loan task includes at least one of: applying a payment to the defaulted loan, determining whether a borrower associated with the defaulted loan is eligible for a payment program of a payment source, generating a communication to a borrower associated with the defaulted loan, generating a communication to a non-borrower associated with the defaulted loan, and requesting a payment for the defaulted loan from a payment source.

32. The system of claim 22, wherein the identified loan event includes a loan event that relates the loan state to a loan state in a different group of loan states.

33. The system of claim 32, wherein the different groups of loan states are associated with different aspects of processing the defaulted loan, in which the different aspects relating to at least one of: due diligence data collection and reporting and payment collection and allocation.

34. A processor-readable medium including instructions for processing a defaulted loan, the processor-readable medium including instructions to cause a processor to:
receive a group of loan states, loan events that relate the loan states, and loan tasks that are associated with the loan events, in which at least some of the loan states, loan events, and loan tasks are at least partially based on at least one governmental regulation,
associate a defaulted loan with a loan state,
identify a loan event that relates the loan state to another loan state, and
based on detecting the identified loan event, perform the loan task associated with the identified loan event.

35. The processor-readable medium of claim 34, further comprising instructions to:
update the loan state, and
iteratively return to identifying a loan event that relates the loan state to another loan state.

36. The processor-readable medium of claim 34, wherein the identified loan event includes a synchronous loan event that relates the loan state to a chronologically next loan state.

37. The processor-readable medium of claim 36, further comprising instructions to:
convert the identified synchronous loan event to a loan event time, and
generate in a first queue a first queue entry that includes data representing the loan event time and at least one of: the defaulted loan, the loan state, the identified synchronous loan event, and the loan task associated with the identified synchronous loan event.

38. The processor-readable medium of claim 37, wherein the instructions to detect include instructions to:
detect a first queue time for the first queue that is not less than the loan event time.

39. The processor-readable medium of claim 38, further comprising instructions to:
based on detecting a first queue time for the first queue that is not less than the loan event time, generate in a second queue a second queue entry that includes data representing at least one of: the defaulted loan, the loan state, the identified synchronous loan event, and the loan task associated with the identified synchronous loan event.

40. The processor-readable medium of claim 34, wherein the identified loan event is asynchronous and the instructions to detect include instructions to:
receive from a payment source at least one of: payment data and processing data related to the defaulted loan.

41. The processor-readable medium of claim 40, wherein the payment source includes at least one of: an administrative wage garnishment program, a borrower associated with the defaulted loan, a federal treasury offset program, a loan consolidation program, a loan rehabilitation program, a loan repurchase program, and a state treasury offset program.

42. The processor-readable medium of claim 40, wherein the processing data includes data related to an eligibility of a borrower associated with the defaulted loan for a payment program of the payment source.

43. The processor-readable medium of claim 34, wherein the loan task includes at least one of: applying a payment to the defaulted loan, determining whether a borrower associated with the defaulted loan is eligible for a payment program of a payment source, generating a communication to a borrower associated with the defaulted loan, generating a communication to a non-borrower associated with the defaulted loan, and requesting a payment for the defaulted loan from a payment source.

44. The processor-readable medium of claim 34, wherein the identified loan event includes a loan event that relates the loan state to a loan state in a different group of loan states.

45. The processor-readable medium of claim 44, wherein the different groups of loan states are associated with different aspects of processing the defaulted loan, in which the different aspects relating to at least one of: due diligence data collection and reporting and payment collection and allocation.
